(19) United States
(12) Patent Application Publication
(10) Pub. No.: US 2004/0257730 A1
(43) Pub. Date: Dec. 23, 2004

(54) Power supply method and power supply system

(76) Inventors: Kenshi Suzuki, Osaka-shi (JP); Masanobu Koganeya, Osaka-shi (JP); Takushi Hara, Osaka-shi (JP)

Correspondence Address: MCDERMOTT WILL & EMERY LLP, 600 13TH STREET, N.W., WASHINGTON, DC, 20005-3096, US

(21) Appl. No.: 10/491,651

(22) PCT Filed: Feb. 17, 2003
(86) PCT No.: PCT/JP03/01668

(30) Foreign Application Priority Data
Feb. 21, 2002 (JP) 2002-45402

(51) Int. Cl. H02H 3/00

(52) U.S. Cl. 361/62

(57) ABSTRACT

A power supply method is provided in which a PPS can easily supply a commensurate amount of electric power from the one or more power generating units so as to be consumed by the one or more specific loads. According to one aspect of the present invention, a secondary battery is prepared; the difference between the amount of electric power generated by one or more power generating units and the power consumption of one or more specific loads is calculated; and depending on the calculated difference, electricity is supplied from the secondary battery to the one or more loads or a power transmission line network through an inverter, or the secondary battery is charged with electricity supplied from the one or more power generating units or the power transmission line network through a converter so as to solve such difference.

### TECHNICAL FIELD

The present invention relates to a power supply method and power supply system in which a difference between electric power supplied by a power generating unit to a power transmission line network and power consumption of a specific load connected to the power transmission line network is calculated, and a power generating unit supplies a commensurate amount of electric power to be consumed by the load so as to solve the difference. Particularly, the invention relates to an improved power supply method and system, in which a specially designated power producer and supplier (hereinafter, “PPS”) having a power generating unit supplies power to a power transmission line network managed by an electric utility such that a commensurate amount of electric power is supplied relative to the power consumption of the load which a specific user manages by connecting with the power transmission line network.

### BACKGROUND ART

In order to supply power to the load used by a specific user, a PPS (i.e., Power Producer and Supplier), which is established according to the deregulation of the electric utility, has its own power generating unit and uses a power transmission line network owned and controlled by an electric utility (i.e., an existing electric power company). For supplying electric power to users, in principle, the PPS must generate and supply a commensurate amount of electric power through the power transmission line network of the power company on a consignment basis in compliance with the amount of power consumed by the loads of the users. If such power supply from the PPS becomes out of the range of the commensurate amount, the power company which is assigned by the PPS to transmit the commensurate amount of power must supplement the shortage of power supply or take a surplus amount of electric power, as the case may be. Therefore, an arrangement such as shown in FIG. 5 is made between the PPS and the power company concerning such supplementary supply and taking of surplus power.

That is, when electric power supply by the PPS becomes short of the commensurate amount, the supply shortage is supplemented by power supply from the power company, and the PPS pays the power company a charge for such supplementary power supply. The power rates in such case are set by each power company: e.g., 10.55 yen/kWh if disparity from the commensurate amount is within 3%, and 15.83 yen/kWh, which is about 1.5 times, if the disparity exceeds 3%.

On the other hand, when electric power supply by the PPS becomes surplus over the commensurate amount, the power company purchases the surplus power at 3 yen/kWh if the disparity over the commensurate amount is within 3%, and the power company takes the surplus power free of charge if the disparity exceeds 3%.

The commensurate amount is managed by a unit period of 30 minutes (unit period), and a penalty is imposed on the PPS in addition to the charge of 15.83 yen/kWh if the condition in which the disparity exceeding 3% continues for 2 hours or more, which is considered to be a failure.

### DISCLOSURE OF THE INVENTION

A PPS adjusts the output of a power-generating unit in order to achieve the power supply of commensurate amount. It is very difficult, however, to achieve the commensurate amount completely because the power consumption of a load changes bit by bit as shown in FIG. 4(a), for example. Therefore, a PPS relies on a power company, to which the PPS has assigned the transmission of its output power, with respect to supplementary power supply for the shortfall of its output power or taking of a surplus amount of its out power. Actually, however, such an arrangement as shown in FIG. 5 tends to become an obstacle in the business management of the PPS.

The present invention was made in view of the above-mentioned situation. The object of first through sixth aspects of the present invention is to provide power supply methods in which a PPS can easily supply a commensurate amount of electric power according to the amount of power consumed by the loads of users. The object of seventh through twelfth aspects of the present invention is to provide power supply systems in which a PPS can easily supply a commensurate amount of electric power according to the amount of power consumed by the loads of users.

In the power supply method according to a first aspect of the invention, a secondary battery is prepared, and depending on the calculation of difference between the amount of electric power generated by one or more power generating units and the power consumption of one or more specific loads, the calculated difference is solved by supplying a commensurate amount of electric power from the power generating units so as to be consumed by the loads such that electricity is supplied from the secondary battery to the load or a power transmission line network through an inverter, or the secondary battery is charged with electricity supplied from the power generating units or the power transmission line network through a converter.

The power supply method according to a second aspect of the invention is characterized in that when the absolute value of the difference is greater than a given value in an initial given period during the unit period in which a commensurate amount of electric power is to be supplied, either electric supply from the secondary battery or charging to the secondary battery is performed so as to solve the difference, and in the remaining period after the initial given period, either electric supply from the secondary battery or charging to the secondary battery is performed so as to solve differences including unsolved differences accumulated during the initial given period.

The power supply method according to a third aspect of the invention is characterized in that when a detected storage amount of the secondary battery is below a first storage amount, the secondary battery is charged to a second storage amount which is greater than the first storage amount.

The power supply method according to a fourth aspect of the invention is characterized in that during a time zone in which the power consumption of a load is relatively low, the secondary battery is charged to a third storage amount which is greater than the second storage amount.

The power supply method according to a fifth aspect of the invention is characterized in that the needed amount of charge is calculated when charging the secondary battery, and the electric power which the power generating unit supplies is increased according to the needed amount of charge thus determined.

The power supply method according to a sixth aspect of the invention is characterized in that when a detected storage amount becomes equal to or above the second storage amount or equal to or above the third storage amount, the electric power which the power generating unit supplies is decreased.

The power supply system according to a seventh aspect of the invention comprises: a secondary battery; a calculating means for calculating differences between the electric power supplied by one or more power generating units and the power consumption of one or more specific loads; and a means for supplying electric power from the secondary battery to the loads or to a power transmission line network through an inverter, or charging the secondary battery from the power generating units or from the power transmission line network through a converter so as to solve such calculated differences such that the power supply system supplies from the power generating units a commensurate amount of electric power to be consumed by the loads.

According to the power supply method of the first aspect of the invention and the power supply system of the seventh aspect of the invention, the calculating means calculates the difference between the electric power supplied by one or more power generating units and the power consumption of one or more specific loads. In order to solve the calculated difference, the means for performing electric supply or charging supplies electricity to the specific loads or the power transmission line network through an inverter, or charges the secondary battery with electricity from the generating units or the power transmission line network through the converter such that a commensurate amount of electric power to be consumed by the specific loads is supplied from the power generating units. Thus, the power supply method and the power supply system enable the PPS to supply a commensurate amount of electric power easily according to the amount of power consumed by the loads of users.

The power supply system according to an eighth aspect of the invention further comprises: a means for determining whether or not the absolute value of the above-mentioned difference is greater than a given value in an initial given period during the unit period in which a commensurate amount of electric power is to be supplied; a means for performing electric supply from the secondary battery or charging to the secondary battery in order to solve the difference when such difference is determined to exist; and a means for solving the difference, including unsolved difference accumulated in the initial given period, by supplying electricity from the secondary battery or charging to the secondary battery in the remaining period after the initial given period during the unit period.

In the power supply method according to the second aspect of the invention and the power supply system according to the eighth aspect of the invention, when the absolute value of the difference is determined to be greater than a given value in an initial given period during the unit period in which a commensurate amount of electric power is to be supplied, the means for performing electric supply or charging either supplies electricity from the secondary battery or charges the secondary battery, depending on the situation so as to solve the difference. Moreover, the means for solving a difference solves the difference including a unsolved difference accumulated in the initial given period, by supplying electricity from the secondary battery or charging to the secondary battery in the remaining period after the initial given period during the unit period.

Thus, the power supply method and the power supply system enable the PPS to supply a commensurate amount of electric power easily in compliance with the amount of power consumed by the loads of users, and also enable the reduction of burden of the secondary battery, converter, and inverter.

The power supply system according to a ninth aspect of the invention further comprises: a detecting means for detecting the storage amount of the secondary battery; a determining means for determining whether the detected storage amount is equal to or less than a first storage amount; and a charging means for charging to the second storage amount, which is greater than the first storage amount, if the detected storage amount is equal to or less than the first storage amount.

In the power supply method according to the third aspect of the invention and the power supply system according to the ninth aspect of the invention, the detecting means detects the storage amount of the secondary battery, and the determining means determines whether or not the detected storage amount is equal to or less than the first storage amount. When the detected storage amount is determined by the determining means to be less than the first storage amount, the charging means charges to the second storage amount which is greater than the first storage amount.

Thus, with the power supply method and the power supply system the PPS can supply a commensurate amount of electric power easily in compliance with the amount of power consumed by the loads of users, the burden of the secondary battery can be reduced, and the frequency of adjusting the amount of power to be generated by the power generating unit can be reduced, whereby the efficient operation of the power generating unit can be achieved.

The power supply system according to a tenth aspect of the invention is further provided with a means for charging the secondary battery to a third storage amount, which is greater than the second storage amount, in a time zone when the power consumption of the load is relatively low.

In the power supply method according to the fourth aspect of the invention and the power supply system according to the tenth aspect of the invention, the charging means charges the secondary battery to the third storage amount which is greater than the second storage amount during a time zone when the power consumption of a specific load is relatively low.

Thus, with the power supply method and the power supply system, the PPS can supply a commensurate amount of electric power easily in compliance with the amount of power consumed by the loads of users; the load-leveling operation of a power generator as shown in FIG. 4(d) can be achieved; an improved working ratio and efficient operation of a power generator can be achieved; and electric power generated at night can be sold in the daytime, whereby the PPS business can be expanded.

The power supply system according to an eleventh aspect of the invention are further equipped with a calculating means for calculating the needed amount of charge when charging the secondary battery and a increasing means for increasing, according to the needed amount of charge thus calculated, electric power to be supplied by the power generating unit.

In the power supply method according to the fifth aspect of the invention and the power supply system according to the eleventh aspect of the invention, the calculating means calculates the needed amount of charge when the secondary battery is charged, and the increasing means increases, according to the needed amount of charge thus calculated, electric power to be supplied by the power generating unit.

Thus, the power supply method and the power supply system enable the PPS to supply a commensurate amount of electric power easily in compliance with the amount of power consumed by the loads of users, and also enable the reduction of burden of the secondary battery.

The power supply system according to a twelfth aspect of the invention further comprises a determining means for determining whether detected storage amount is equal to or above a second storage amount or equal to or above a third storage amount and a decreasing means for decreasing electric power which the power generating unit supplies when the detected storage amount is equal to or above the second storage amount or equal to or above the third storage amount.

In the power supply method according to the sixth aspect of the invention and the power supply system according to the twelfth aspect of the invention, the determining means determines whether the detected storage amount of the secondary battery is equal to or above the second storage amount or equal to or above the third storage amount, and when the detected storage amount is determined by the determining means to be equal to or above the second storage amount, or equal to or above the third storage amount, the decreasing means decreases the electric power which the power generating unit supplies.

Thus, with the power supply method and the power supply system the PPS can supply a commensurate amount of electric power easily in compliance with the amount of power consumed by the loads of users, the burden of the secondary battery can be reduced, and the efficient operation of the power generating unit can be achieved.

### BRIEF DESCRIPTION OF THE DRAWING

FIG. 1 is a block diagram showing the composition of an embodiment of the power supply method and the power supply system according to the present invention.

FIG. 2 is a flow chart showing the operation of a power supply system according to the present invention.

FIG. 3 is a flow chart showing the operation of a power supply system according to the present invention.

FIGS. 4(a) through 4(e) are timing charts showing the operation of a power supply system according to the present invention.

FIGS. 5(a) and 5(b) are diagrams showing an example of arrangement between a PPS and an electric utility.

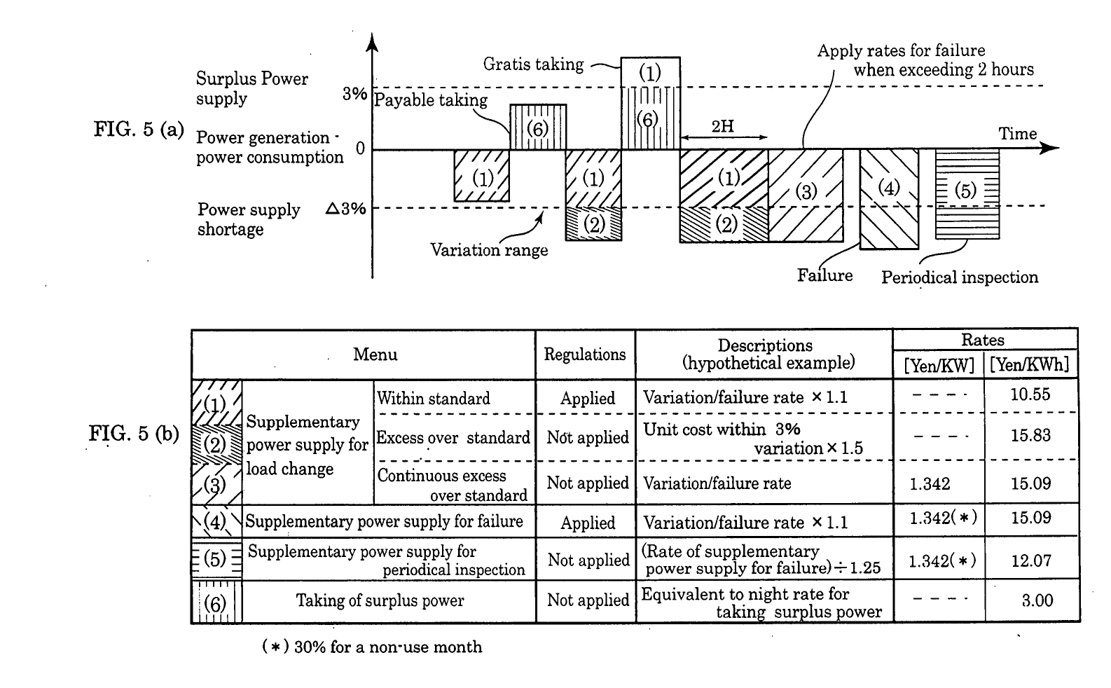

### BEST MODE FOR CARRYING OUT THE INVENTION

Embodiments of the present invention are described hereinafter in reference to the accompanying drawings.

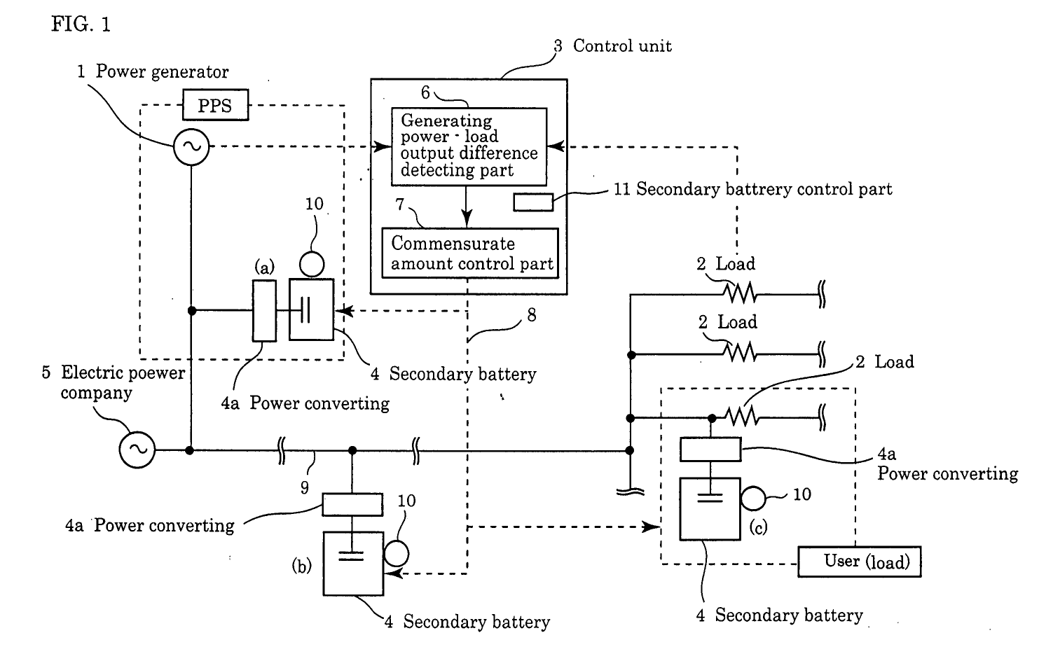

FIG. 1 is a block diagram showing the composition of an embodiment of the power supply method and power supply system according to the present invention. In this power supply system, loads 2 (electric power loads) of the customers of a PPS are connected with a power transmission line network 9 of an existing electric power company (power generating/transformation facilities) 5. A power generator 1 used and controlled by the PPS is connected to the power transmission line network 9, and one or more secondary batteries 4 are connected to the power transmission line network 9 at a position between the power generator 1 and the loads 2 of the customers of the PPS and through power converting equipment 4a (i.e., a converter and an inverter) provided between the secondary battery 4 and the power transmission line network 9. The secondary battery 4 is provided with a detector 10 for detecting the storage amount thereof. The location of installing a secondary battery 4 may be (a) within a facility (electric power station) in which the power generator 1 used and controlled by the PPS is installed, (b) on the power transmission line network 9, or (c) within facilities where the loads 2 of the customers exist.

A control unit 3, which controls the power generator 1 of the PPS and the secondary battery 4, is connected to the power generator 1, the secondary battery 4, and the loads 2 of the customers through a communication line such that the remote control of the power generator 1 and the secondary battery 4 is performed. The location of installing the control unit 3 is not restricted to a particular place.

The control unit 3 is equipped with a generating power —load output difference detecting part 6 which detects by calculation the difference between generated energy and load power consumption, a commensurate amount control part 7 which performs the commensurate amount control of electric power, and a secondary battery control part 11 which controls a secondary battery 4 by remote control. As for the power generator 1, the installation number thereof may be one unit or more than one unit, and it is generally a power generator at a thermoelectric power station, although it may be a wind power generating unit or a photovoltaic power generating unit, etc.

Regardless of any of the above-mentioned places (a), (b), and (c) where one or more secondary batteries 4 are arranged, it is possible to operate in the same way. If the secondary batteries 4 are installed in (c) the facilities where the loads 2 of the customers are installed, an advantage is that the space for installing a large-sized secondary battery (storage battery) can be distributed.

Also, if the secondary batteries 4 are installed in (c) the facilities in which the loads 2 of the customers exist, it is possible to afford the secondary batteries 4 with such features as an emergency power source and power compensation function against power outage and momentary voltage sag. Thus, a service additional to simple electric power retail can be provided to each customer. If the location of the secondary battery 4 is (b) on the power transmission line network 9, it can cope with the loads 2 of a plurality of customers.

The secondary battery 4 may be owned by the PPS or a third person other than the PPS. In such case, the third person may lease the secondary battery 4 to the PPS, or otherwise may sell the PPS the service of controlling the commensurate amount by acquiring data on the loads 2 of the customers and the power generation of the PPS. Moreover, the third person may provide an additional service to the customers of the PPS.

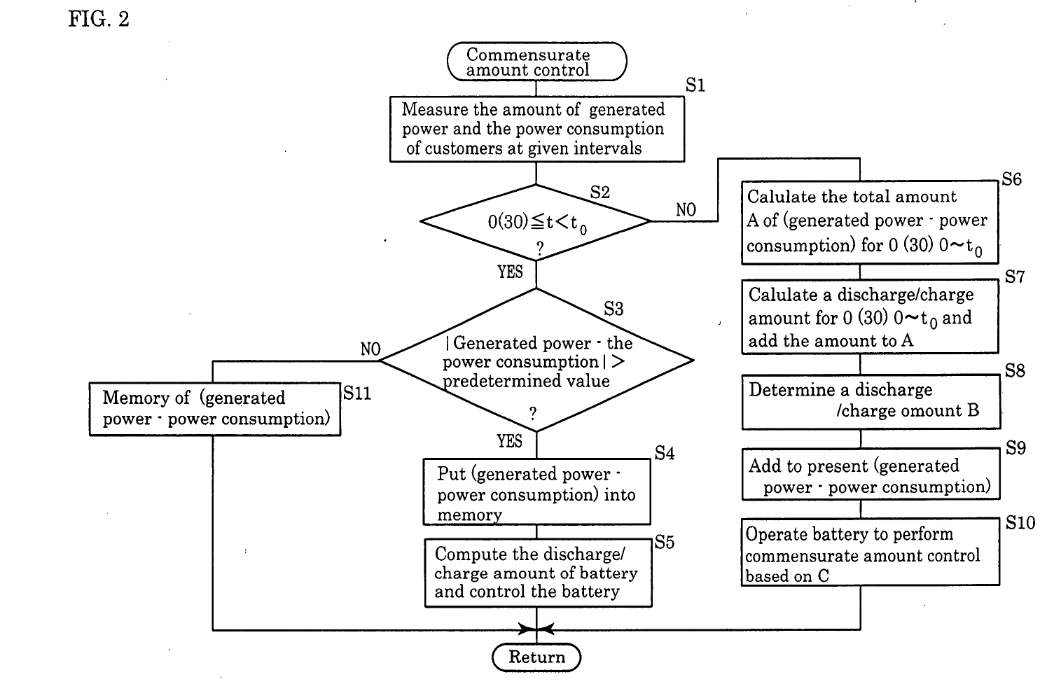

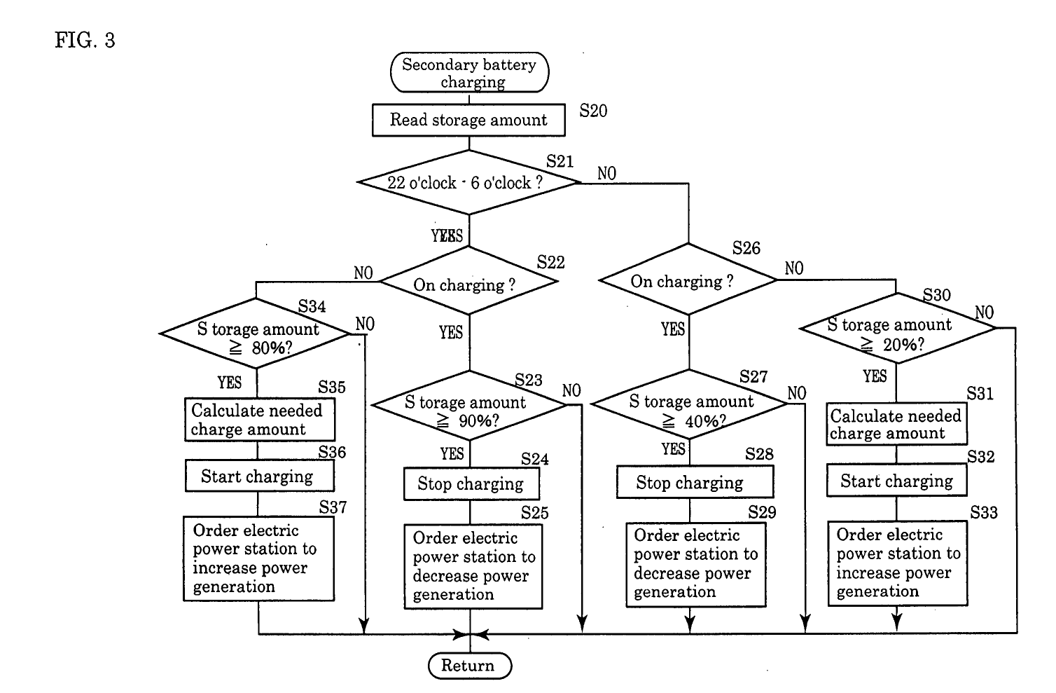

The operation of a power supply system having such a composition as described above will be explained below in reference to the flow charts of FIGS. 2 and 3.

First, the control unit 3 simulates the load quantity of customers and plans power generation for a day beforehand. The control unit 3 measures the amount of generated power and the power consumption of the loads 2 of the customers (i.e., users) at given intervals (S1), and performs calculation and control operations as follows.

If it is a given period t₀(e.g., 20 minutes) from the beginning of a unit period of 30 minutes in which the electric power control of commensurate amount is to be achieved (S2), the control unit 3 calculates (generated power—power consumption) and determines whether or not the resultant absolute value is greater than a predetermined value (S3).

When the calculated absolute value is found not to be greater than the predetermined value (S3), the control unit 3 puts the calculation of (generated power—power consumption) into memory (S11) and returns to S1.

If the calculated absolute value is found to be greater than the predetermined value (S3), the control unit 3 puts the calculation of (generated power—power consumption) into memory (S4), and at the same time computes the discharge/charge amount of the secondary battery 4, and based on the calculation, controls the secondary battery 4 so as to achieve (generated power—power consumption=0) by performing discharge or charge (S5), and returns to S1.

If it is not the given period to from the beginning of the unit period of 30 minutes in which the electric power control of commensurate amount is to be achieved (S2), the control unit 3 calculates the total amount A of (generated power—power consumption) for a period from the beginning of the unit period of 30 minutes through the given period to (S6). Subsequently, the control unit 3 computes the discharge/charge amount of the secondary battery 4 for a period from the beginning of the unit period of 30 minutes through the given period to, and adds the resultant value to the total amount A (S7).

Based on the added total amount A (S7), the control unit 3 determines a discharge/charge amount B of the secondary battery 4 for a remaining period after the given period to during the unit period of 30 minutes (S8).

Subsequently, the control unit 3 calculates the present (generated power—power consumption), and adds the discharge/charge amount B thereto and seeks a discharge/charge amount C (S9).

The control unit 3 controls the secondary battery 4 to perform discharge and charge based on the discharge/charge amount C (S10), and returns to S1.

It is possible to achieve power generation control economically with the secondary battery 4 by adopting a suitable control interval as mentioned above, since a period of 30 minutes is the unit period in which commensurate amount should be achieved, although the commensurate amount can be controlled on the order of seconds in terms of a unit period because response speed is very fast.

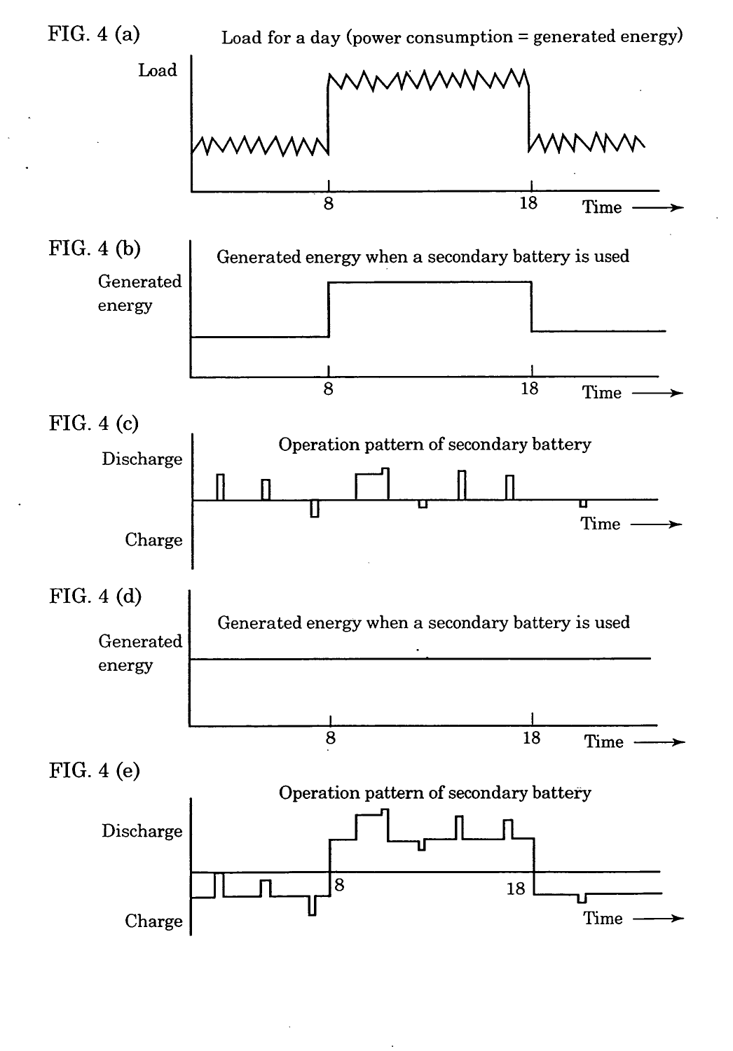

In a case in which there is a change of load such as shown in FIG. 4(a), such change can be compensated by the discharge and charge of the secondary battery 4 for commensurate amount control as mentioned above, and accordingly the power generator 1 can be operated without making its output to change as shown in FIG. 4(b). In this case, the discharging and charging pattern of the secondary battery 4 becomes as shown in FIG. 4(c), for example.

The control unit 3 reads the storage amount (i.e., residual quantity) detected by the detector 10 at given intervals in order to charge the secondary battery 4 (S20 in FIG. 3), in addition to performing commensurate amount control by means of the secondary battery 4 as described above.

If it is a time during a period of 22 o'clock—6 o'clock, for example, in which the electric power consumption by the loads 2 is low (S21), the control unit 3 detects whether or not the secondary battery 4 is being charged (S22), and if it is under charging, the control unit 3 determines whether or not the detected storage amount (S20) is equal to or more than 90%, for example (S23).

If the control unit 3 finds the detected storage amount (S20) to be equal to or more than 90% (S23), it stops charging (S24), and orders the electric power station to cause the power generator 1 to decrease its power generation (S25), and returns to S1. If the control unit 3 finds the detected storage amount (S20) to be less than 90% (S23), it returns to S1.

If the secondary battery 4 is not on charging (S22), the control unit 3 determines whether the detected storage amount (S20) is equal to or less than 80%, for example (S34).

If the detected storage amount (S20) is equal to or less than 80% (S34), the control unit 3 calculates the amount of needed charge (S35) and begins charging according to the calculated amount of needed charge (S36), and orders an electric power station to increase the generation of the power generator 1 (S37), and returns to S1.

The control unit 3 returns to S1, if the detected storage amount (S20) is more than 80% (S34).

If it is not during the time period of 22 o'clock—6 o'clock (S21), the control unit 3 judges whether or not the secondary battery 4 is on charging (S26), and if under charging, the control unit 3 determines whether or not the detected storage amount (S20) is equal to or more than 40%, for example (S27).

If the detected storage amount (S20) is equal to or more than 40% (S27), the control unit 3 stops charging (S28), and orders the electric power station to decrease the generation of the power generator 1 (S29), and returns to S1.

The control unit 3 returns to S1 if the detected storage amount (S20) is not equal to or more than 40% (S27).

If the secondary battery 4 is not on charging (S26), the control unit 3 determines whether the detected storage amount (S20) is equal to or less than 20%, for example (S30).

If the detected storage amount (S20) is equal to or less than 20% (S30), the control unit 3 calculates the amount of needed charge (S31), and starts charging according to the calculated amount of needed charge (S32), and orders the electric power station to increase the generation of the power generator 1 (S33), and returns to S1.

The control unit 3 returns to S1, if the detected storage amount (S20) is not equal to or less than 20% (S30).

Thus, while performing the commensurate amount control as shown in the flow chart of FIG. 2, load-leveling operation can be performed such that the secondary battery 4 is charged during a time zone in the night when electric power load is low, and the secondary battery 4 is discharged during a time zone in the daytime when electric power load is high. In this case, the power generator 1 can operate continuously without changing its load very much for 24 hours as shown in FIG. 4(d). In such case, the discharge of energy increases in the daytime, and the charge of energy increases at night, whereby the discharging and charging pattern of the secondary battery 4 becomes as shown in FIG. 4(e), for example.

### INDUSTRIAL APPLICABILITY

With the power supply method according to the first aspect of the invention and the power supply system according to the seventh aspect of the invention, a PPS can easily supply a commensurate amount of electricity in compliance with the power consumption of the loads of users.

With the power supply method according to the second aspect of the invention and the power supply system according to the eighth aspect of the invention, a PPS can easily supply a commensurate amount of electric power in accordance with the amount of electric power consumed by the loads of users, and also the burden of a secondary battery, a converter, and inverter can be reduced.

With the power supply method according to the third aspect of the invention and the power supply system according to the ninth aspect of the invention, a PPS can easily supply a commensurate amount of electric power in accordance with the amount of power consumed by the loads of users, and the burden of the secondary battery can be reduced.

With the power supply method according to the fourth aspect of the invention and the power supply system according to the tenth aspect of the invention, a PPS can easily supply a commensurate amount of electric power in accordance with the amount of electric power consumed by the loads of users; load-leveling operation can be performed; the improved working ratio and efficient operation of a power generator are possible; the electric power generated at night can be sold in the daytime, whereby the business of the PPS can be expanded.

With the power supply method according to the fifth aspect of the invention and the power supply system according to the eleventh aspect of the invention, a PPS can easily supply a commensurate amount of electric power in accordance with the amount of electric power consumed by the loads of users, and the burden of the secondary battery can be reduced.

With the power supply method according to the sixth aspect of the invention and the power supply system according to the twelfth aspect of the invention, a PPS can easily supply a commensurate amount of electric power in accordance with the amount of electric power consumed by the loads of users, the burden of the secondary battery can be reduced, and the efficient operation of a power generating unit is possible.

1. A power supply method, comprising:
preparing a secondary battery;
calculating difference between the amount of electric power generated by one or more power generating units and the power consumption of one or more specific loads; and
supplying a commensurate amount of electric power from the one or more power generating units so as to be consumed by the one or more specific loads, wherein depending on the calculated difference, electricity is supplied from the secondary battery to the one or more loads or a power transmission line network through an inverter, or the secondary battery is charged with electricity supplied from the one or more power generating units or the power transmission line network through a converter so as to solve such difference.

2. A power supply method according to claim 1, wherein either electric supply from the secondary battery or charging to the secondary battery is performed so as to solve the difference when the absolute value of the difference is greater than a given value in an initial given period during the unit period in which a commensurate amount of electric power is to be supplied, and differences including unsolved differences accumulated in the initial given period are solved by electric supply from the secondary battery or charging to the secondary battery in the remaining period after the initial given period during the unit period.

3. A power supply method according to claim 1, wherein when the storage amount of the secondary battery is detected to be below a first storage amount, the secondary battery is charged beforehand to a second storage amount which is greater than the first storage.

4. A power supply method according to claim 2, wherein when the storage amount of the secondary battery is detected to be below a first storage amount, the secondary battery is charged beforehand to a second storage amount which is greater than the first storage.

5. A power supply method according to claim 3, wherein the secondary battery is charged beforehand to a third storage amount which is greater than the second storage amount in a time zone in which the power consumption of the one or more loads is small.

6. A power supply method according to claim 4, wherein the secondary battery is charged beforehand to a third storage amount which is greater than the second storage amount in a time zone in which the power consumption of the one or more loads is small.

7. A power supply method according to claim 3, wherein when the secondary battery is charged, the amount of needed charge is calculated, and electric power supplied by the one or more power generating units is increased according to the calculated needed amount of charge.

8. A power supply method according to claim 4, wherein when the secondary battery is charged, the amount of needed charge is calculated, and electric power supplied by the one or more power generating units is increased according to the calculated needed amount of charge.

9. A power supply method according to claim 5, wherein when the secondary battery is charged, the amount of needed charge is calculated, and electric power supplied by the one or more power generating units is increased according to the calculated needed amount of charge.

10. A power supply method according to claim 3, wherein electric power to be supplied by the one or more power generating units is decreased when the detected storage amount becomes equal to or above the second storage amount or equal to or above the third storage amount.

11. A power supply method according to claim 4, wherein electric power to be supplied by the one or more power generating units is decreased when the detected storage amount becomes equal to or above the second storage amount or equal to or above the third storage amount.

12. A power supply method according to claim 5, wherein electric power to be supplied by the one or more power generating units is decreased when the detected storage amount becomes equal to or above the second storage amount or equal to or above the third storage amount.

13. A power supply method according to claim 7, wherein electric power to be supplied by the one or more power generating units is decreased when the detected storage amount becomes equal to or above the second storage amount or equal to or above the third storage amount.

14. A power supply system comprising:
a secondary battery;
a calculating means for calculating differences between the electric power supplied by one or more power generating units and the power consumption of one or more specific loads; and
a means for supplying electricity from the secondary battery to the one or more specific loads or to a power transmission line network through an inverter or charging the secondary battery from the one or more power generating units or from the power transmission line network through a converter so as to solve such calculated differences, whereby the one or more power generating units supply a commensurate amount of electric power to be consumed by the one or more specific loads.

15. A power supply system according to claim 14 further comprising:
a means for determining whether or not the absolute value of the differences is greater than a given value in an initial given period during the unit period in which a commensurate amount of electric power is to be supplied;
a means for performing electric supply from the secondary battery or charging to the secondary battery in order to solve the difference when such difference is determined to exist; and
a means for solving differences including unsolved differences accumulated in the initial given period, by supplying electricity from the secondary battery or charging to the secondary battery in the remaining period after the initial given period during the unit period.

16. A power supply system according to claim 14, further comprising:
a detecting means for detecting the storage amount of the secondary battery;
a determining means for determining whether a detected storage amount is equal to or less than a first storage amount; and
a charging means for charging, if the detected storage amount is equal to or less than the first storage amount, to a second storage amount greater than the first storage amount.

17. A power supply system according to claim 15, further comprising:
a detecting means for detecting the storage amount of the secondary battery;
a determining means for determining whether a detected storage amount is equal to or less than a first storage amount; and
a charging means for charging, if the detected storage amount is equal to or less than the first storage amount, to a second storage amount greater than the first storage amount.

18. A power supply system according to claim 14, further comprising a means for charging the secondary battery to a third storage amount greater than the second storage amount in a time zone in which the power consumption of the one or more specific loads is low.

19. A power supply system according to claim 16, further comprising:
a means for calculating a needed amount of charge when charging; and
a means for increasing, according to such calculated needed amount of charge, electric power to be supplied by the one or more power generating units.

20. A power supply system according to claim 16, further comprising:
a means for determining whether a detected storage amount is equal to or above the second storage amount or equal to or above third storage amount; and
a means for decreasing electric power to be supplied by the one or more power generating units when the detected storage amount is equal to or above the second storage amount or equal to or above the third storage amount.
